(19) United States
(12) Patent Application Publication
(10) Pub. No.: US 2020/0180252 A1
(43) Pub. Date: Jun. 11, 2020

(54) PRESS SYSTEM

(71) Applicant: KOMATSU INDUSTRIES CORPORATION, Kanazawa-shi, Ishikawa (JP)

(72) Inventors: Hitoshi SAKURAI, Kanazawa-shi, Ishikawa (JP); Koyo YAMAZAKI, Kanazawa-shi, Ishikawa (JP); Atsuo OKETANI, Kanazawa-shi, Ishikawa (JP); Toshihiro MINAMI, Kanazawa-shi, Ishikawa (JP); Masanori KIMURA, Kanazawa-shi, Ishikawa (JP)

(73) Assignee: KOMATSU INDUSTRIES CORPORATION, Kanazawa-shi, Ishikawa (JP)

(21) Appl. No.: 16/615,524

(22) PCT Filed: Jun. 8, 2018
(86) PCT No.: PCT/JP2018/022062

§ 371 Date: Nov. 21, 2019

(30) Foreign Application Priority Data
Sep. 22, 2017 (JP) 2017-182583

(51) Int. Cl. B30B 15/14; B21D 43/09; B21D 43/02; B30B 1/26; B30B 15/30

(52) U.S. Cl. CPC B30B 15/148; B21D 43/09; B30B 15/30; B30B 1/263; B21D 43/021

(57) ABSTRACT

A press system capable of achieving a reduced number of man-hours required for generation of a motion is provided. A controller automatically generates a press motion based at least on a feed-allowable height, a touch position, and a work end position, automatically generates a feeder motion based at least on a feed-allowable height and a feed length, and automatically generates a synthesized motion by synthesizing the press motion and the feeder motion.

### TECHNICAL FIELD

The present invention relates to a press system.

### BACKGROUND ART

For example, Japanese Patent Laying-Open No. 2013-184222 (PTL 1) discloses a method of setting a rotary motion at the time when a crankshaft is rotated by a servo motor in a conventional press.

### CITATION LIST

### Patent Literature

PTL 1: Japanese Patent Laying-Open No. 2013-184222

### SUMMARY OF INVENTION

### Technical Problem

A primary feature of a servo press resides in its ability to perform various slide motions. Though a slide motion can more arbitrarily be set, setting of the motion is complicated and a large number of man-hours are required for creating a desired motion. A material feeding apparatus (feeder) in coordination with a press also requires a large number of man-hours for creating an optimal motion for enhancing productivity.

An object of the present invention is to provide a press system capable of achieving a reduced number of man-hours required for generation of a motion.

### Solution to Problem

A press system according to the present invention includes a press portion, a transportation portion, and an operation portion. The press portion includes a slide to which an upper die is attachable, the slide moving upward and downward, and a bolster to which a lower die is attachable. The press portion is configured to press work a workpiece by upward and downward movement of the slide with respect to the bolster. The transportation portion is configured to transport the workpiece. The operation portion is operated for inputting a slide position parameter relating to a position in an upward and downward direction of the slide and a transportation parameter relating to an operation of the transportation portion. The slide position parameter includes a feed-allowable height at which the workpiece can be transported without interfering with the upper die, a touch position at which the upper die comes in contact with the workpiece, and a work end position at which working ends. The transportation parameter includes a feed length representing a length of transportation of the workpiece by the transportation portion in a direction of transportation of the workpiece after end of press working of the workpiece and before start of next press working. The press system further includes a controller. The controller is configured to automatically generate a press motion based at least on the feed-allowable height, the touch position, and the work end position, to automatically generate a feeder motion based at least on the feed-allowable height and the feed length, and to automatically generate a synthesized motion by synthesizing the press motion and the feeder motion.

### Advantageous Effects of Invention

According to the press system in the present invention, the number of man-hours required for generating a motion can be reduced.

### BRIEF DESCRIPTION OF DRAWINGS

FIG. 1 is a diagram illustrating a construction of a press system based on an embodiment.

FIG. 2 is a perspective view of a press apparatus based on the embodiment.

FIG. 3 is a lateral cross-sectional view showing a main portion of the press apparatus.

FIG. 4 is a plan view of a partial cross-section showing another main portion of the press apparatus.

FIG. 5 is a diagram illustrating overview of a drive system of the press system based on the embodiment.

FIG. 6 is a functional block diagram of a CPU based on the embodiment.

FIG. 7 is a diagram showing a first example of an input screen shown on a display.

FIG. 8 is a diagram showing one example of a table used for setting a touch speed.

FIG. 9 is a schematic diagram showing arrangement of a die and a workpiece when a slide is located at a feed-allowable height.

FIG. 10 is a schematic diagram showing arrangement of the die and the workpiece when the slide is located at a touch position.

FIG. 11 is a schematic diagram showing arrangement of the die and the workpiece when the slide is located at a work end position.

FIG. 12 is a diagram showing a second example of the input screen shown on the display.

FIG. 13 is a diagram showing a third example of the input screen shown on the display.

FIG. 14 is a diagram illustrating an angle of rotation of a main shaft corresponding to each position representing a slide position parameter.

FIG. 15 is a flowchart illustrating generation of a motion in the press system based on the embodiment.

FIG. 16 is a diagram showing a press motion and a feeder motion generated by the press system based on the embodiment.

FIG. 17 is a diagram showing an exemplary output screen shown on the display.

FIG. 18 is a diagram showing a fourth example of the input screen shown on the display.

### DESCRIPTION OF EMBODIMENTS

The present embodiment will be described in detail with reference to the drawings. The same or corresponding elements in the drawings have the same reference characters allotted and description thereof will not be repeated.

The present example relates to a press apparatus and describes a forward feed press apparatus by way of example.

<Overall Construction>

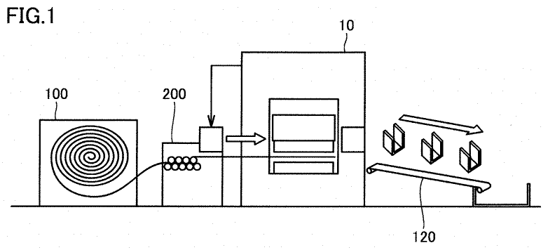

FIG. 1 is a diagram illustrating a construction of a press system based on an embodiment. As shown in FIG. 1, the press system includes an uncoiler 100, a leveler feeder (a transportation portion) 200, a press apparatus (a press portion) 10, and a conveyor 120.

A coil material (a strip plate) is wound around uncoiler 100. In the present embodiment, press working of the coil material as a workpiece (material) will be described. The coil material unwound from uncoiler 100 is transported to press apparatus 10 by leveler feeder 200.

Leveler feeder 200 adjusts a position of a feed height of the coil material transported from uncoiler 100 to press apparatus 10 and transports the coil material to press apparatus 10 under an operation condition (a feeder motion) in a set direction of transportation.

Press apparatus 10 press works the coil material transported from leveler feeder 200.

Conveyor 120 transports the workpiece formed by press working by press apparatus 10. Conveyor 120 can transport the formed workpiece, for example, to a next press apparatus.

Components in the press system are in synchronization with one another, and a series of operations is sequentially and successively performed. The coil material is transported from uncoiler 100 via leveler feeder 200 to press apparatus 10. Then, press apparatus 10 performs press working, and the worked workpiece is transported by conveyor 120. A series of processes above is repeated.

The above construction of the press system is by way of example and limitation thereto is not particularly intended.

Leveler feeder 200 is operated in accordance with an instruction from press apparatus 10. In this connection, a controller configured to control leveler feeder 200 is provided in press apparatus 10.

Though the present example describes a construction in which the controller configured to control leveler feeder 200 is provided in press apparatus 10, limitation thereto is not intended, and for example, a controller configured to control press apparatus 10 may be provided on a side of leveler feeder 200. A controller configured to control press apparatus 10 and leveler feeder 200 may be arranged at a position different from press apparatus 10 and leveler feeder 200 to remotely control press apparatus 10 and leveler feeder 200. The embodiment describes an example in which a single controller controls both of leveler feeder 200 and press apparatus 10.

<Press Apparatus>

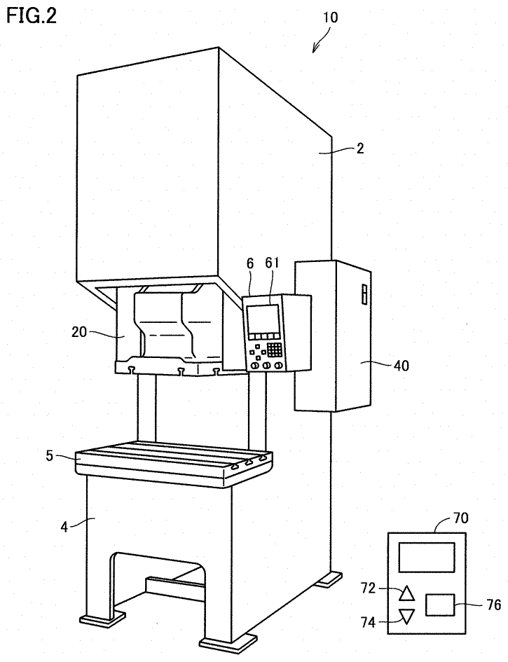

FIG. 2 is a perspective view of press apparatus 10 based on the embodiment.

FIG. 2 shows a forward feed press apparatus without a plunger by way of example.

Press apparatus 10 includes a main body frame 2, a slide 20, a bed 4, a bolster 5, a control panel 6, and a controller 40.

Slide 20 is supported in a substantially central portion of main body frame 2 of press apparatus 10 as being vertically movable. Bolster 5 attached onto bed 4 is arranged under slide 20. Controller 40 is provided laterally to main body frame 2. Control panel 6 connected to controller 40 is provided laterally to main body frame 2 and in front of controller 40.

An upper die of dice for working a workpiece is removably attached to a lower surface of slide 20. A lower die of the dice for working a workpiece is removably attached to an upper surface of bolster 5. A prescribed workpiece corresponding to the dice is placed on the lower die, the upper die is lowered together with slide 20, and the workpiece is press worked as being sandwiched between the upper die and the lower die.

A remote controller (remote control unit) 70 provided to communicate with a main body of press apparatus 10 and to allow external remote control is provided. An operator (a person responsible for operation) can perform various setting operations by operating remote controller 70. Remote controller 70 can communicate with controller 40 to operate press apparatus 10 in accordance with an instruction therefrom.

The present example shows that remote controller 70 is provided with an up button 72 and a down button 74 for vertically operating slide 20 and an enter button 76.

Control panel 6 is provided to input various types of data necessary for controlling press apparatus 10, and includes a switch and a numeric keypad for inputting data and a display 61 configured to show a setting screen and data output from press apparatus 10.

Such a programmable display that a transparent touch switch panel is attached to a front surface of a graphic display such as a liquid crystal display or a plasma display is adopted as display 61.

Control panel 6 may include a data input device which receives input of data from an external storage medium such as an integrated circuit (IC) card where data set in advance is stored or a communication device which transmits and receives data wirelessly or through a communication line.

Though the present example describes a construction in which both of control panel 6 and remote controller 70 are provided for press apparatus 10, the construction of press apparatus 10 is by way of example and limitation thereto is not intended. For example, only one of control panel 6 and remote controller 70 may be provided for press apparatus 10.

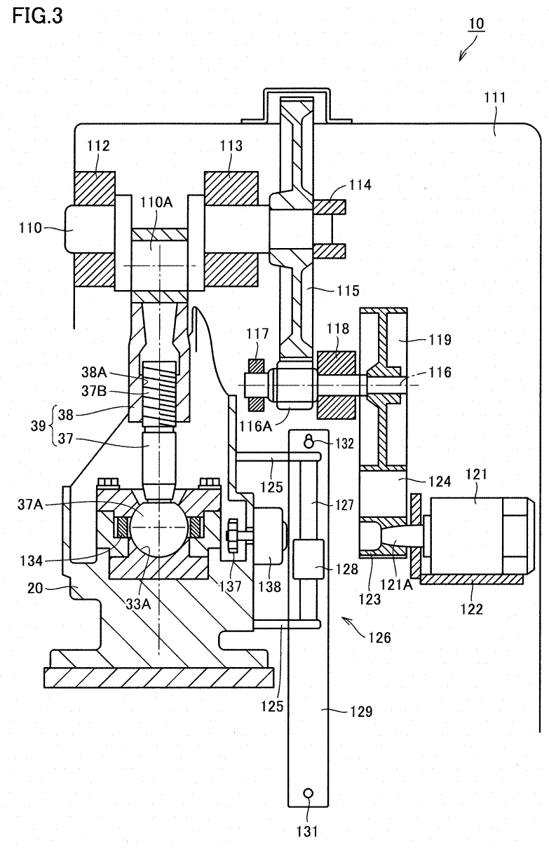

FIG. 3 is a lateral cross-sectional view showing a main portion of press apparatus 10. As shown in FIG. 3, press apparatus 10 is implemented by a servo press.

Press apparatus 10 includes a servo motor 121, a spherical hole 33A, a screw shaft 37, a spherical portion 37A, a thread portion 37B, and a connecting rod main body 38. Press apparatus 10 further includes a female thread portion 38A, a connecting rod 39, a main shaft 110, an eccentric portion 110A, a side frame 111, bearing portions 112 to 114, a main gear 115, a power transmission shaft 116, a transmission gear 116A, bearing portions 117 and 118, and a pulley 119.

In press apparatus 10, servo motor 121 drives slide 20. In spherical hole 33A provided in an upper portion of slide 20, spherical portion 37A provided at a lower end of screw shaft 37 for adjusting a die height is rotatably inserted so as not to come off. Spherical hole 33A and spherical portion 37A make up a spherical joint. Thread portion 37B of screw shaft 37 is exposed upward through slide 20, and screwed to female thread portion 38A of connecting rod main body 38 provided above screw shaft 37. Screw shaft 37 and connecting rod main body 38 make up extendable connecting rod 39.

The die height refers to a distance from a lower surface of slide 20 at the time when slide 20 is arranged at a bottom dead center to an upper surface of bolster 5.

An upper portion of connecting rod 39 is rotatably coupled to eccentric portion 110A like a crank provided in main shaft 110. Main shaft 110 is movably supported by bearing portions 112, 113, and 114 located at three front and rear locations between a pair of left and right thick side frames 111 which form main body frame 2. Main gear 115 is attached to a rear portion of main shaft 110.

Main gear 115 is meshed with transmission gear 116A of power transmission shaft 116 provided below. Power transmission shaft 116 is movably supported by bearing portions 117 and 118 located at two front and rear locations between side frames 111. Power transmission shaft 116 has a rear end attached to driven pulley 119. Pulley 119 is driven by servo motor 121 arranged below.

Press apparatus 10 further includes a bracket 122, an output shaft 121A, a pulley 123, a belt 124, a bracket 125, a position detector 126, a rod 127, a position sensor 128, an auxiliary frame 129, and bolts 131 and 132.

Servo motor 121 is supported between side frames 111 with bracket 122 substantially in an L shape being interposed. Servo motor 121 has output shaft 121A projecting along a front-rear direction of press apparatus 10, and motive power is transmitted by belt 124 wound around driving pulley 123 provided on output shaft 12IA and driven pulley 119.

A pair of brackets 125 projecting rearward between side frames 111 from two upper and lower locations is attached on a rear surface side of slide 20. Rod 127 which implements position detector 126 such as a linear scale is attached between upper and lower brackets 125. Rod 127 is provided with a scale for detecting a vertical position of slide 20 and vertically movably fitted into position sensor 128 similarly implementing position detector 126. Position sensor 128 is fixed to auxiliary frame 129 provided in one side frame 111.

Auxiliary frame 129 is formed in a vertically elongated manner. The auxiliary frame has a lower portion attached to side frame 111 by bolt 131 and an upper portion vertically slidably supported by bolt 132 inserted in a vertically elongated hole. Auxiliary frame 129 has thus only any one side (a lower side in the present embodiment) of upper and lower sides fixed to side frame 111 and has the other side vertically movably supported. Therefore, the auxiliary frame is not affected by contraction and extension caused by variation in temperature of side frame 111. Position sensor 128 can thus accurately detect a slide position and a die height position without being affected by such contraction and extension of side frame 111.

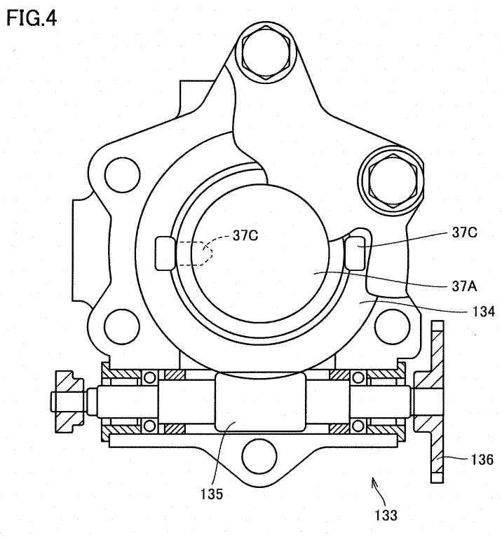

A slide position of slide 20 and a die height are adjusted by a slide position adjustment mechanism 133 (FIG. 4) provided in slide 20. FIG. 4 is a plan view of a partial cross-section showing another main portion of press apparatus 10.

As shown in FIG. 4, slide position adjustment mechanism 133 is constituted of a worm wheel 134 attached to an outer circumference of spherical portion 37A with a pin 37C being interposed, a worm gear 135 meshed with worm wheel 134, an input gear 136 attached to an end of worm gear 135, and an induction motor 138 including an output gear 137 (FIG. 3) meshed with input gear 136. Induction motor 138 is in a flat shape shorter in axial length and constructed to be compact. Screw shaft 37 can be turned by a rotary motion of induction motor 138 with worm wheel 134 being interposed. A length of screwing between thread portion 37B of screw shaft 37 and female thread portion 38A of connecting rod main body 38 is thus varied to adjust the slide position of slide 20 and the die height.

<Configuration of Drive System of Press System>

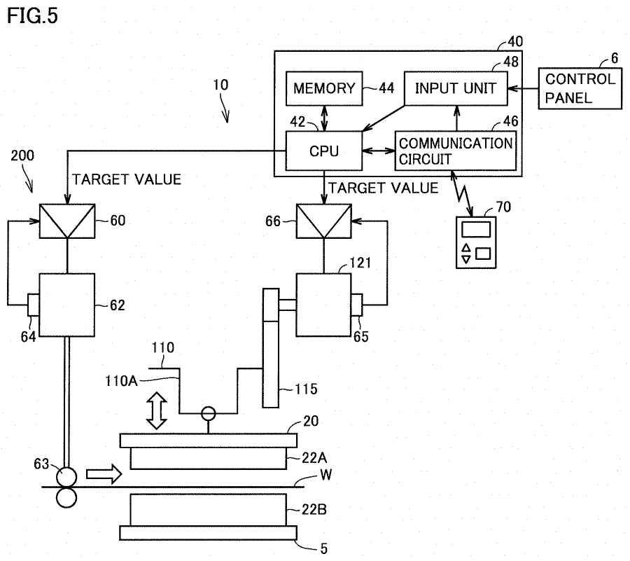

FIG. 5 is a diagram illustrating overview of a drive system of the press system based on the embodiment.

As shown in FIG. 5, leveler feeder 200 includes a transportation roller 63, a servo motor 62, an encoder 64, and a servo amplifier 60.

Press apparatus 10 includes controller 40, a servo amplifier 66, servo motor 121, an encoder 65, main gear 115, main shaft 110, eccentric portion 110A, slide 20, an upper die 22A, a lower die 22B, and bolster 5.

Controller 40 includes a central processing unit (CPU) 42, a memory 44, a communication circuit 46, and an input unit 48.

Communication circuit 46 is provided to be able to communicate with remote controller 70.

CPU 42 outputs a target value to servo amplifier 60. Servo amplifier 60 gives a speed instruction to servo motor 62 based on the target value. Transportation roller 63 performs an operation to transport a workpiece W as servo motor 62 is driven.

Encoder 64 outputs a feedback signal based on the number of rotations of servo motor 62 in accordance with the speed instruction to servo amplifier 60.

Servo amplifier 60 adjusts the number of rotations of servo motor 62 to a value in accordance with the target value by controlling supply of electric power to servo motor 62 based on the feedback signal from encoder 64.

Through the processing, CPU 42 controls a speed of transportation in the operation to transport workpiece W.

Similarly, CPU 42 outputs a target value to servo amplifier 66. Servo amplifier 66 gives a speed instruction to servo motor 121 based on the target value. Main gear 115 drives main shaft 110 as servo motor 121 is driven. As main shaft 110 is driven, eccentric portion 110A is rotated. Eccentric portion 110A is coupled to slide 20, and slide 20 to which upper die 22A is attached moves upward and downward in accordance with a rotation of eccentric portion 110A. As slide 20 is lowered to a position of the bottom dead center under an operation condition (press motion) in the set upward and downward direction, press working of workpiece W transported to a position between upper die 22A and lower die 22B is performed.

Upper die 22A is a movable die which is attached to slide 20 and is reciprocatively vertically moved integrally with slide 20 with upward and downward movement of slide 20. Lower die 22B is a fixed die attached to bolster 5 and placed and fixed onto bolster 5. As slide 20 moves upward and downward with respect to bolster 5, workpiece W is sandwiched between upper die 22A and lower die 22B and press worked.

Encoder 65 outputs a feedback signal based on the number of rotations of servo motor 121 in accordance with a speed instruction to servo amplifier 66.

Servo amplifier 66 adjusts the number of rotations of servo motor 121 to a value in accordance with the target value by controlling supply of electric power to servo motor 121 based on the feedback signal from encoder 65.

Through the processing, CPU 42 controls a speed of slide 20 in the upward and downward movement.

CPU 42 based on the embodiment performs processing for synchronizing a transportation operation by leveler feeder 200 (which is also simply referred to as a feeder) with the upward and downward movement of slide 20 of press apparatus 10 based on control data stored in memory 44.

Specifically, memory 44 stores control data in which upward and downward movement of slide 20 is associated with a workpiece transportation operation by leveler feeder 200.

Input unit 48 accepts input of various parameters. In the present example, input unit 48 accepts input of a parameter through control panel 6 or remote controller 70. An operator inputs various parameters by operating a switch and a numeric keypad in control panel 6 or each button on remote controller 70. Control panel 6 and remote controller 70 implement the operation portion in the embodiment.

A parameter received by input unit 48 includes a slide position parameter relating to a position of slide 20 in the upward and downward direction. A parameter received by input unit 48 includes a transportation parameter relating to an operation by leveler feeder 200.

<Generation of Motion>

A method of generating a motion based on the embodiment will now be described.

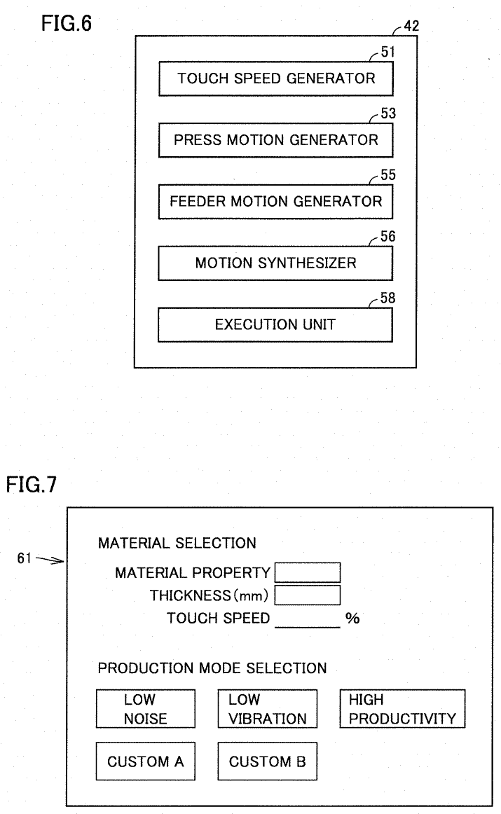

FIG. 6 is a functional block diagram of CPU 42 based on the embodiment.

As shown in FIG. 6, CPU 42 includes a touch speed generator 51, a press motion generator 53, a feeder motion generator 55, a motion synthesizer 56, and an execution unit 58.

Each one in the functional block diagram is implemented in coordination with each component (such as communication circuit 46) by execution by CPU 42 of a prescribed application program stored in memory 44.

Touch speed generator 51 sets a speed (touch speed) of slide 20 at the time when slide 20 is lowered and upper die 22A comes in contact with workpiece W based on a material property and a thickness of workpiece W input to input unit 48.

FIG. 7 is a diagram showing a first example of an input screen shown on display 61. An operator inputs a material property and a thickness of workpiece W in the input screen shown in FIG. 7, by operating control panel 6 or remote controller 70. The operator selects a production mode in the input screen shown in FIG. 7 by operating control panel 6 or remote controller 70.

The production mode includes a “low noise” mode in which primary importance is placed on suppression of noise, a “low vibration” mode in which a touch speed is set to such an extent that vibration can be suppressed, although noise is higher than in the “low noise” mode, and a “high productivity” mode in which primary importance is placed on productivity. The operator can also edit any touch speed (“custom A” and “custom B”).

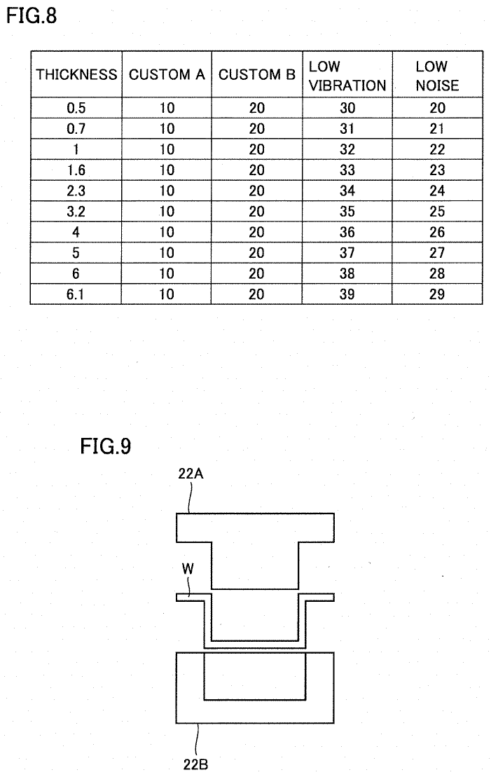

FIG. 8 is a diagram showing one example of a table used for setting a touch speed. FIG. 8 shows a speed of touch to workpiece W having a specific material property determined in correspondence with each thickness and each production mode. For example, for workpiece W having a thickness of 1 mm, a touch speed in an example where the “low vibration” mode is selected is set to 32 mm/second, and a touch speed in an example where the “low noise” mode is selected is set to 22 mm/second. For workpiece W having a thickness of 3.2 mm, a touch speed in an example where the “low vibration” mode is selected is set to 35 mm/second, and a touch speed in an example where the “low noise” mode is selected is set to 25 mm/second.

In the example shown in FIG. 8, such setting for “custom A” is made that a touch speed is set to 10 mm/second regardless of a thickness, and such setting for “custom B” is made that a touch speed is set to 20 mm/second regardless of a thickness. Columns of “custom A” and “custom B” shown in FIG. 8 can be edited by an operator in any manner, whereas columns of “low vibration” and “low noise” shown in FIG. 8 cannot be edited by the operator.

Though not shown in FIG. 8, when the “high productivity” mode is selected, setting is made such that a touch speed is set as a highest speed of slide 20.

A touch speed table shown in FIG. 8 is stored in memory 44 (FIG. 5) of controller 40. The touch speed table as shown in FIG. 8 is stored in memory 44 for each material property of workpiece W. Touch speed tables different for each method of working such as punching, bending, and drawing for workpieces W identical in material property are stored in memory 44. Memory 44 saves a database showing correspondence of a material property, a thickness, and a method of working of workpiece W with a touch speed.

Touch speed generator 51 calls a corresponding touch speed table from memory 44 based on a material property and a method of working of workpiece W input to the input screen shown in FIG. 7. Touch speed generator 51 further reads a value of a touch speed corresponding to the thickness and the production mode of workpiece W input to the input screen in FIG. 7 from the called touch speed table. A touch speed is thus set.

Press motion generator 53 automatically generates a press motion based on a slide position parameter input to input unit 48. The slide position parameter includes a feed-allowable height, a touch position, and a work end position.

Feeder motion generator 55 automatically generates a feeder motion based on a transportation parameter input to input unit 48. The transportation parameter includes a feed length.

Motion synthesizer 56 automatically generates a synthesized motion by automatically synthesizing the press motion generated by press motion generator 53 and a feeder motion generated by feeder motion generator 55.

The feed-allowable height refers to a lower limit of a position of slide 20 where upper die 22A does not interfere with transported workpiece W. FIG. 9 is a schematic diagram showing arrangement of the die and workpiece W when slide 20 is located at the feed-allowable height. When slide 20 is distant from bolster 5 by a distance greater than the feed-allowable height, workpiece W can be transported without interfering with upper die 22A.

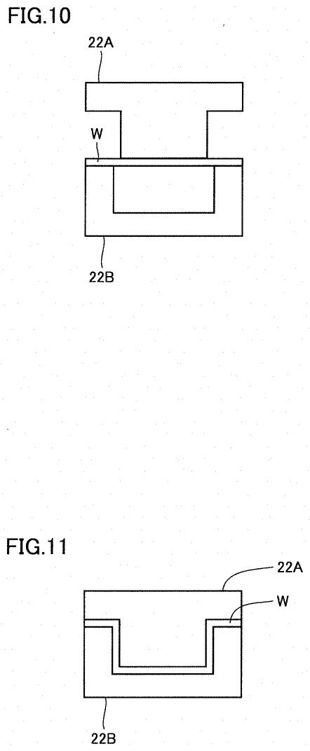

The touch position refers to a position of slide 20 at the time when upper die 22A comes in contact with workpiece W. FIG. 10 is a schematic diagram showing arrangement of the die and workpiece W when slide 20 is located at the touch position. When slide 20 lowered toward bolster 5 reaches the touch position, upper die 22A comes in contact with workpiece W placed on lower die 22B.

The work end position refers to a position of slide 20 at the time point of end of press working of workpiece W. FIG. 11 is a schematic diagram showing arrangement of the die and workpiece W when slide 20 is located at the work end position. When slide 20 lowered toward bolster 5 reaches the work end position, press working of workpiece W ends.

The feed length refers to a length of transportation of workpiece W by leveler feeder 200 in the direction of transportation of workpiece W after end of press working of workpiece W and before start of next press working. A speed of transportation of workpiece W transported by leveler feeder 200 is referred to as a feed rate. The feed rate is saved in memory 44. Alternatively, the feed rate may be included in a transportation parameter input to input unit 48.

Execution unit 58 controls a transportation operation by leveler feeder 200 and press working by press apparatus 10 based on a synthesized motion generated by motion synthesizer 56. Specifically, execution unit 58 outputs a target value for driving servo motors 62 and 121 to servo amplifiers 60 and 66 based on the synthesized motion, and performs synchronization processing for synchronizing the press motion and the feeder motion with each other.

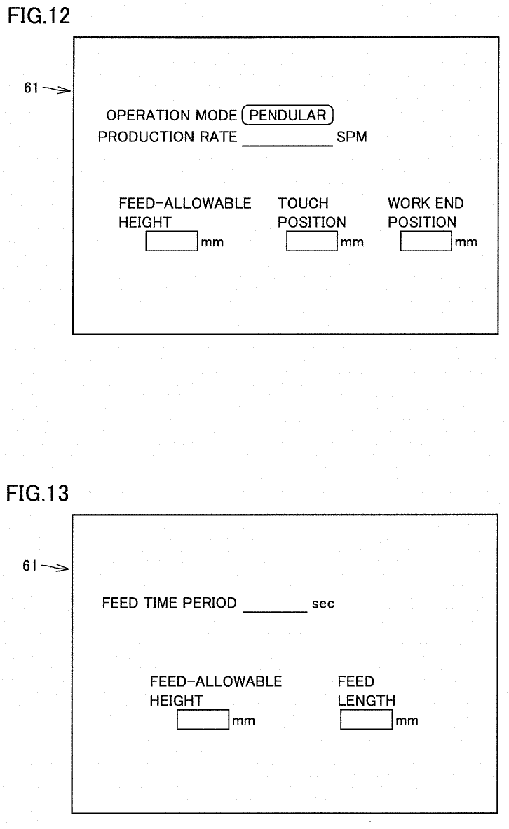

FIG. 12 is a diagram showing a second example of the input screen shown on display 61. The operator inputs a feed-allowable height, a touch position, and a work end position in the input screen shown in FIG. 12 by operating control panel 6 or remote controller 70. When press motion generator 53 generates a press motion, an operation mode for maximizing an amount of production per unit time is set. Furthermore, a production rate (unit: shot per minute (SPM)) is set. The set operation mode and production rate are shown in the input screen in FIG. 12.

The operation mode includes a rotary motion, a reverse motion, and a pendular motion.

The rotary motion refers to an operation mode in which eccentric portion 110A (FIG. 3) is rotated in one direction to drive slide 20 in one cycle.

The reverse motion refers to an operation mode in which slide 20 is reversely driven between a down stroke and an up stroke between two angles of rotation corresponding to prescribed lower limit position and upper limit position set between angles of rotation of eccentric portion 110A corresponding to the top dead center and the bottom dead center of slide 20.

The pendular motion refers to an operation mode in which slide 20 is reciprocatively driven across the bottom dead center by setting as two upper limit positions, two angles of rotation distant by a prescribed angle in a direction of forward rotation and a direction of reverse rotation from a bottom dead center angle of rotation of eccentric portion 110A corresponding to the bottom dead center of slide 20 and rotationally driving the slide in one direction from one upper limit position across the bottom dead center angle of rotation to the other upper limit position.

FIG. 12 illustrates setting of the pendular motion as the operation mode.

FIG. 13 is a diagram showing a third example of the input screen shown on display 61. The operator inputs a feed length in the input screen shown in FIG. 13 by operating control panel 6 or remote controller 70. CPU 42 calculates a feed time period based on the feed length and the feed rate. The calculated feed time period is shown in the input screen in FIG. 13.

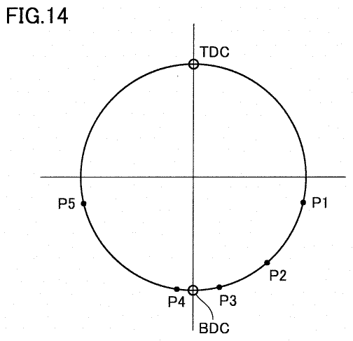

FIG. 14 is a diagram illustrating an angle of rotation of main shaft 110 corresponding to each position representing a slide position parameter. FIG. 14 shows angles of rotation of main shaft 110 corresponding to a top dead center TDC, a bottom dead center BDC, a feed-allowable height P1, a touch position P2, a work end position P3, a jump prevention height P4, and a feed-allowable height P5 of slide 20.

The operation mode of slide 20 is set to the pendular motion in which the slide is reciprocatively driven across bottom dead center BDC with feed-allowable heights P1 and P5 being defined as upper limit positions. Slide 20 starts lowering from feed-allowable height P1, sequentially passes touch position P2 and work end position P3, reaches bottom dead center BDC, moves upward from bottom dead center BDC, passes jump prevention height P4, moves to feed-allowable height P1, and stops.

As shown in FIG. 14, work end position P3 is set as a position higher than bottom dead center BDC. Lowered slide 20 passes work end position P3 before reaching bottom dead center BDC.

Jump prevention height P4 is set as a position higher than bottom dead center BDC. Slide 20 starts moving upward after it passes bottom dead center BDC, and passes jump prevention height P4. In order to prevent wobble of workpiece W between upper die 22A and lower die 22B at the time when upper die 22A is raised after end of press working of workpiece W, a speed of slide 20 while it is moved from work end position P3 to jump prevention height P4 is set to be low.

A different position of jump prevention height P4 can be set for each condition of a material property, a thickness, and a method of working of workpiece W. Set jump prevention height P4 is saved in memory 44 (FIG. 5). When jump prevention height P4 corresponding to workpiece W to be press worked has not been saved in memory 44 at the time of change in material property, thickness, or method of working of workpiece W, jump prevention height P4 is set by making trials a plurality of times before starting working.

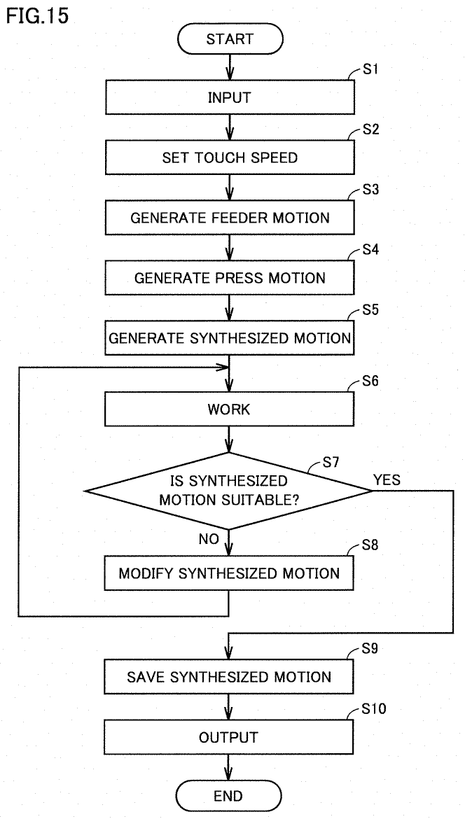

FIG. 15 is a flowchart illustrating generation of a motion in the press system based on the embodiment.

As shown in FIG. 15, initially, in step S1, various parameters are input to input unit 48. Specifically, an operator inputs parameters necessary for generating a motion in the input screens shown in FIGS. 7, 12, and 13.

Then, in step S2, a touch speed is set. Specifically, touch speed generator 51 sets a touch speed by referring to the touch speed table shown in FIG. 8, based on a material property and a thickness of workpiece W input to the input screen shown in FIG. 7.

Then, in step S3, a feeder motion is generated. Specifically, feeder motion generator 55 generates a feeder motion based on a feed length and a feed rate input to the input screen shown in FIG. 13.

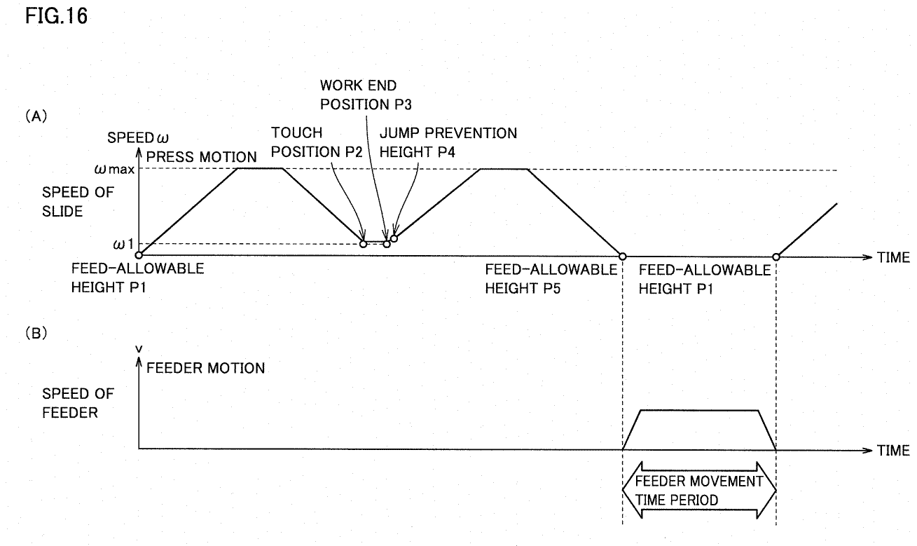

FIG. 16 is a diagram showing a press motion and a feeder motion generated by the press system based on the embodiment. The abscissa in the graph in FIG. 16(A) represents time and the ordinate represents an angular speed a) of main shaft 110 based on rotational drive by servo motor 121. An angular speed ωmax represents a value set as a maximum value of the angular speed of main shaft 110. An angular speed ω1 represents an angular speed of main shaft 110 corresponding to a touch speed set in step S2. As main shaft 110 rotates at angular speed ω1, a lowering speed of slide 20 is set to a touch speed. In FIG. 16(A), feed-allowable height P1, touch position P2, work end position P3, jump prevention height P4, and feed-allowable height P5 are plotted. The abscissa in the graph in FIG. 16(B) represents time and the ordinate represents a speed of transportation v of workpiece W.

As shown in FIG. 16(B), the transportation speed is increased up to the set feed rate at a prescribed acceleration from a state that workpiece W remains stopped (speed of transportation v=0). After reaching the feed rate, transportation of workpiece W at the set feed rate is continued to a position where the speed can be lowered by deceleration at a prescribed acceleration to speed of transportation v=0 at the time point of transportation of workpiece W by a set transportation length. A prescribed value of an acceleration at the time of increase or decrease in transportation speed is saved in memory 44.

Workpiece W is decelerated from the set feed rate at a prescribed acceleration. Speed of transportation v=0 is achieved at the time point of transportation of workpiece W by the set transportation length. Transportation of workpiece W is thus completed. The feeder motion is generated as set forth above.

Referring back to FIG. 15, in step S4, a press motion is generated. Specifically, press motion generator 53 generates a press motion based on the feed-allowable height (P1), the touch position (P2), and the work end position (P3) input in the input screen shown in FIG. 12 and the touch speed set in step S2.

At this time, whether or not the generated press motion is the pendular motion or the rotary motion is determined. Specifically, two types of press motions for driving servo motor 121 based on the pendular motion and driving servo motor 121 based on the rotary motion are generated. Then, of the pendular motion and the rotary motion, a press motion higher in production rate is selected.

As shown in FIG. 16(A), feed-allowable height P1 refers to a position where slide 20 remains stopped, and hence angular speed ω of main shaft 110 at feed-allowable height P1 is zero. Slide 20 starts lowering from feed-allowable height P1 toward bottom dead center BDC, and is accelerated at a prescribed acceleration until maximum angular speed ωmax is reached. After maximum angular speed ωmax is reached, rotation of main shaft 110 at maximum angular speed ωmax is continued to a position where the speed can be lowered by deceleration at a prescribed acceleration to touch speed ω1 at an angle of rotation corresponding to touch position P2. Prescribed values of maximum angular speed ωmax of main shaft 110 and an acceleration at the time of acceleration and deceleration are saved in memory 44.

Main shaft 110 is decelerated from maximum angular speed ωmax and rotated at angular speed ω1 at the time point when slide 20 reaches touch position P2. Thereafter, main shaft 110 is rotated at equal angular speed ω1 until slide 20 reaches work end position P3. Slide 20 is thus lowered at the touch speed from touch position P2 to work end position P3.

When slide 20 reaches work end position P3, main shaft 110 (and slide 20) starts acceleration. While slide 20 is moving between work end position P3 and jump prevention height P4, in order to prevent wobble of workpiece W, slide 20 is moved at a speed slightly higher than the touch speed and main shaft 110 is rotated at a speed slightly higher than angular speed ω1.

When slide 20 reaches jump prevention height P4, slide 20 is again accelerated at a prescribed acceleration until maximum angular speed ωmax is reached. After maximum speed ωmax is reached, rotation of main shaft 110 at maximum angular speed ωmax is continued to a position where the speed can be lowered by deceleration at a prescribed acceleration to a zero angular speed at an angle of rotation corresponding to feed-allowable height P5.

Main shaft 110 is decelerated from maximum angular speed ωmax and stops rotation at the time point when slide 20 reaches feed-allowable height P5. Slide 20 stops at a position at feed-allowable height P5. The press motion is generated as set forth above.

Then, in step S5, a synthesized motion is generated. Specifically, motion synthesizer 56 generates a synthesized motion by synthesizing the feeder motion generated in step S3 and the press motion generated in step S4.

As shown in FIG. 16, after slide 20 stops at feed-allowable height PS, transportation of workpiece W is started. After workpiece W is transported by a feed length and feed is completed, that is, after lapse of a feeder movement time period, lowering of slide 20 is started. The synthesized motion in which interference between workpiece W and upper die 22A does not occur is thus generated.

At this time, whether the press motion included in the synthesized motion is the pendular motion or the rotary motion is determined. As described above, during generation of the press motion in step S3, of the pendular motion and the rotary motion, a press motion higher in production rate by itself is selected. A motion different from the motion selected in step S3 is newly selected in step S5, if the production rate can further be increased by synthesizing the newly selected motion.

Then, in step S6, workpiece W is worked in accordance with the generated synthesized motion. Execution unit 58 has press working of workpiece W performed based on the generated synthesized motion.

Then, in step S7, whether or not a result of working of workpiece W based on the synthesized motion generated in step S5 is appropriate is determined. For example, torque required for rotation of main shaft 110 is calculated based on a current value of servo motor 121, and when the torque exceeds an allowable value, the result of working is determined as inappropriate. Alternatively, for example, vibration generated during working is determined, and when vibration exceeds an allowable value, the result of working is determined as inappropriate. The allowable value of torque or vibration has been saved in memory 44.

When the result of working is determined as inappropriate (NO in step S7), the synthesized motion is modified in step S8. For example, a speed other than the speed during press working (that is, the touch speed of slide 20 (angular speed ω1 of main shaft 110)) is modified to be lower.

After the synthesized motion is modified, the process returns to step S6, where workpiece W is worked in accordance with the modified synthesized motion. In succession, in step S7, whether or not the result of working of workpiece W based on the modified synthesized motion is appropriate is determined.

When the result of working is determined as appropriate (YES in step S7), the process proceeds to step S9, where the synthesized motion is saved in memory 44.

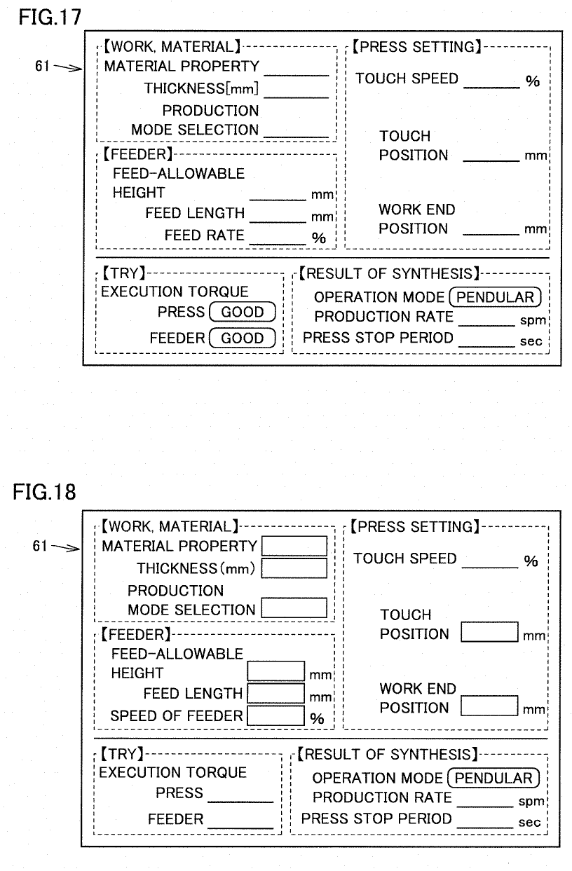

In step S10, the result is output. FIG. 17 is a diagram showing an exemplary output screen shown on display 61. As shown in FIG. 17, values input as a slide position parameter and a transportation parameter and a set and calculated value determined with automatic generation of a motion are shown in a single screen, so that an operator can readily know a state of operation by the press system by viewing that screen on display 61.

Then, the process ends (end).

Though the embodiment above illustrates an example in which various parameters are sequentially input to a plurality of input screens as shown in FIGS. 7 and 12 to 13, the input screens may be integrated into one screen. FIG. 18 is a diagram showing a fourth example of the input screen shown on display 61. To the input screen shown in FIG. 18, a material property and a thickness of workpiece W and a production mode can be input as in FIG. 7, a feed-allowable height, a touch position, and a work end position can be input as in FIG. 12, and a feed-allowable height and a feed length can be input as in FIG. 13. A feed rate (feed speed) can also be input.

For a skilled operator who has already understood which value should be input to the input screen, by integrating the input screens into a single screen, work efficiency can be improved because all information can be input to the single screen and time and efforts for switching between the input screens can be saved.

<Function and Effect>

A function and effect of the present embodiment will now be described.

According to the press system based on the embodiment, as shown in FIG. 16, a press motion is automatically generated by setting a slide position parameter relating to a position in the upward and downward direction of the slide. A feeder motion is automatically generated by setting a transportation parameter relating to an operation of the transportation portion. A fastest press motion in coordination with a material feeding apparatus (leveler feeder 200) can automatically be generated under conditions in which low vibration and low noise are both achieved, by synthesizing the automatically generated press motion and feeder motion. Therefore, man-hours required for setting the motion can be reduced.

The slide position parameter includes a feed-allowable height, a touch position, and a work end position as shown in FIG. 12. These positions are determined by workpiece W to be worked, and has already been known to an operator who operates the press system in the embodiment. A feed length included in a transportation parameter is also determined by workpiece W to be worked and has already been known to the operator. Even an unskilled person with less experience can automatically generate a press motion and a feeder motion by inputting an already known set value as a parameter and can easily generate an optimal motion without causing interference between workpiece W and the die.

The transportation parameter further includes a feed rate. A feeder motion is generated based on a feed length and a feed rate such that leveler feeder 200 is accelerated from a zero speed to a feed rate, kept driven over a distance corresponding to the feed length, and decelerated from the feed rate to the zero speed. The feeder motion can thus automatically be generated.

As shown in FIGS. 7 and 8, a touch speed is set based on a material property and a thickness of workpiece W. A press motion is generated such that a speed of slide 20 is set to zero at the feed-allowable height and the touch speed is maintained from the touch position to the work end position. The press motion can thus automatically be generated.

As shown in FIG. 15, occurrence of such an instance that excessive load is applied to servo motor 121 can be suppressed by determining whether or not a synthesized motion is appropriate based on a result of press working of workpiece W in accordance with the generated synthesized motion.

As shown in FIG. 15, when determination as to the synthesized motion is negative, the synthesized motion is modified so that load applied to servo motor 121 can be made appropriate and the press system can be operated under an appropriate condition with vibration also being suppressed.

By storing and saving the generated synthesized motion in memory 44, the synthesized motion can be read from memory 44 for use when press working under the same condition is subsequently performed, and hence work efficiency can further be improved.

By determining whether the generated press motion is the pendular motion or the rotary motion, of the pendular motion and the rotary motion, a motion higher in production rate is selected and an appropriate press motion can be generated.

Determination as to whether the press motion is the pendular motion or the rotary motion is made in both of automatic generation of the press motion and synthesis of the press motion and the feeder motion, so that a synthesized motion highest in production rate can be generated.

An example in which the operation mode of slide 20 is set to the pendular motion or the rotary motion is described above. The concept in the embodiment described above is applicable also to an example in which a reverse motion is set as the operation mode, without being limited to these operation modes.

The press apparatus is not limited to those of the construction described in the embodiment, and the press apparatus may be constructed such that a plunger and a plunger holder are interposed between the connecting rod and the slide. An eccentric mechanism may have a crankshaft structure or a drum structure.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

2 main body frame; 4 bed; 5 bolster; 6 control panel; 10 press apparatus; 20 slide; 22A upper die; 22B lower die; 37 screw shaft; 38 connecting rod main body; 39 connecting rod; 40 controller; 42 CPU; 44 memory; 46 communication circuit; 48 input unit; 51 touch speed generator; 53 press motion generator; 55 feeder motion generator; 56 motion synthesizer; 58 execution unit; 60, 66 servo amplifier; 61 display; 62, 121 servo motor; 63 transportation roller; 64, 65 encoder; 70 remote controller; 72, 74 button; 76 enter button; 100 uncoiler; 110 main shaft; 110A eccentric portion; 115 main gear; 200 leveler feeder

1. A press system comprising:
a press portion including a slide to which an upper die is attachable, the slide moving upward and downward, and a bolster to which a lower die is attachable, the press portion being configured to press work a workpiece by upward and downward movement of the slide with respect to the bolster;
a transportation portion configured to transport the workpiece;
an operation portion operated for inputting a slide position parameter relating to a position in an upward and downward direction of the slide and a transportation parameter relating to an operation of the transportation portion,
the slide position parameter including a feed-allowable height at which the workpiece can be transported without interfering with the upper die, a touch position at which the upper die comes in contact with the workpiece, and a work end position at which working ends,
the transportation parameter including a feed length representing a length of transportation of the workpiece by the transportation portion in a direction of transportation of the workpiece after end of press working of the workpiece and before start of next press working; and
a controller,
the controller being configured to automatically generate a press motion based at least on the feed-allowable height, the touch position, and the work end position, to automatically generate a feeder motion based at least on the feed-allowable height and the feed length, and to automatically generate a synthesized motion by synthesizing the press motion and the feeder motion.

2. The press system according to claim 1, wherein
the controller is configured to automatically generate the feeder motion based at least on the feed-allowable height, the feed length, and a feed rate representing a speed of the workpiece transported by the transportation portion.

3. The press system according to claim 1, wherein
the operation portion is operated for inputting a material property and a thickness of the workpiece, and
the controller is configured to set a touch speed representing a speed of the slide when the upper die comes in contact with the workpiece based on the material property and the thickness of the workpiece and to automatically generate the press motion based at least on the feed-allowable height, the touch position, the work end position, and the touch speed.

4. The press system according to claim 1, wherein
the controller is configured to determine whether the synthesized motion is suitable based on a result of press working of the workpiece in accordance with the synthesized motion.

5. The press system according to claim 4, wherein
the controller is configured to modify the synthesized motion when the synthesized motion is determined as not suitable.

6. The press system according to claim 1, further comprising a memory configured to store and save the synthesized motion.

7. The press system according to claim 1, wherein
the controller is configured to determine, when the press motion is generated, whether the press motion is a pendular motion or a rotary motion.

8. The press system according to claim 7, wherein
the controller is configured to determine, when the synthesized motion is generated, whether the press motion included in the synthesized motion is the pendular motion or the rotary motion.
